(19) United States
(12) Patent Application Publication
(10) Pub. No.: US 2021/0268961 A1
(43) Pub. Date: Sep. 2, 2021

(54) DISPLAY METHOD, DISPLAY DEVICE, AND DISPLAY SYSTEM

(71) Applicant: HONDA MOTOR CO., LTD., Tokyo (JP)

(72) Inventors: Misaki ASAMI, WAKO-SHI (JP); Masaki MARUYAMA, WAKO-SHI (JP)

(21) Appl. No.: 17/184,018

(22) Filed: Feb. 24, 2021

(30) Foreign Application Priority Data
Feb. 28, 2020 (JP) 2020-033779

(51) Int. Cl. B60R 1/00; G06T 11/20; G06K 9/00; G08G 1/16; G02B 27/01

(52) U.S. Cl. CPC B60R 1/00; G06T 11/203; G06K 9/00805; G08G 1/167; G02B 27/0101; G02B 2027/0141; G06K 9/00362; B60R 2300/205; B60R 2300/301; B60R 2300/8033; G06K 2209/23

(57) ABSTRACT

A display method, display device, and display system including a virtual image display device are configured to detect at least another moving object and an object including a fixed object and to display an image in the vicinity of, or in a position superimposed on, the detected object. When another moving object is detected, the virtual image display device regards this moving object as a target to be watched and displays an exaggerating image corresponding to a surrounding object existing near the target to be watched, in a position superimposed on the surrounding object.

### CROSS-REFERENCE TO RELATED APPLICATION

This application is based upon and claims the benefit of priority from Japanese Patent Application No. 2020-033779 filed on Feb. 28, 2020, the contents of which are incorporated herein by reference.

### BACKGROUND OF THE INVENTION

### Field of the Invention

The present invention relates to display methods, display devices, and display systems, and more particularly to a display method, display device, and display system that can be suitably applied to a mobile object, for example.

### Description of the Related Art

The image display device described in Japanese Laid-Open Patent Publication No. 2001-023091 is intended to achieve an object to detect targets present in the direction of travel of a vehicle and enable the driver to grasp the surrounding conditions easily and reliably.

In order to achieve the object, the image display device of Japanese Laid-Open Patent Publication No. 2001-023091 detects a target present in the direction of travel of the vehicle from images captured by cameras (1R, 1L) mounted on the vehicle, and detects the position of the target. The display screen (41) of a head-up display is divided into three areas. The center area (41a) displays an image captured by one of the cameras and a highlighted image of a target existing within an approach judge area that is set in the direction of travel of the vehicle. The right-hand area (41b) and left-hand area (41c) display icons (ICR, ICL) corresponding to targets existing in entry judge areas that are set outside the approach judge area.

Japanese Laid-Open Patent Publication No. 2005-075190 is intended to achieve an object to provide an automotive display device that allows the driver to easily grasp whether a target is approaching or not.

According to the image display device of Japanese Laid-Open Patent Publication No. 2005-075190, in order to achieve the object, an automotive display device (1) includes a head-up display (14), a preceding vehicle capturing device (11) for capturing a target image, an inter-vehicle distance sensor (10) for measuring the distance from the driver's vehicle (100) to the target, and an approach judge unit (12) for judging whether the target is approaching the driver's vehicle (100) on the basis of the measured inter-vehicle distance and a relative velocity. Then, if a judgement that the target is approaching the driver's vehicle (100) is made, a display control unit (13) generates, on the basis of the captured target image, an enlarged image (15) of the real view of the target that is visually perceived by the driver, and causes the head-up display (14) to display the generated enlarged image (15) in a position superimposed on the real view, in a range lower than a threshold of conscious perception and within a range of unconscious perception.

### SUMMARY OF THE INVENTION

By the way, in a situation where an object that is viewed in a relatively far distance (a moving object like a vehicle) is moving at a higher relative velocity and involves a higher risk of collision than nearest moving objects (e.g. moving objects like vehicles or pedestrians) and relatively nearby objects, it may be desirable to perceive the speed of this “collision-risky” “traffic participant” earlier.

An object of the present invention is to provide a display method, display device, and display system that can display images that are simpler and more readily understandable, compared to alerting displays with letters, signs, etc. or the display of an image corresponding to, e.g. a traffic participant to which the user should pay attention, and that can allow the user to grasp the speed and risk of such a traffic participant earlier.

An aspect of the present invention is directed to a display method for use in a moving object (a vehicle in an embodiment) comprising a display device. The display method detects at least another moving object and an object including a fixed object, and displays an image, by the display device, in a vicinity of the detected object or in a position superimposed on the detected object. In a case where the display method detects the another moving object, the display method regards this another moving object as a target to be watched, displays an image with exaggerating representation corresponding to the object existing near the target to be watched, and causes the display device to display the image in a position superimposed on the object existing near the target to be watched.

Another aspect of the present invention is directed to a display device that includes a surrounding object recognition unit configured to recognize at least another moving object and an object including a fixed object. The display device is configured to display an image in a vicinity of, or in a position superimposed on, the object recognized by the surrounding object recognition unit. The display device includes an exaggerating representation processing unit that is configured to, in a case where the surrounding object recognition unit recognizes the another moving object, regard this another moving object as a target to be watched and generate an image with exaggerating representation corresponding to the object existing near the target to be watched, and the display device displays the image in a position superimposed on the object existing near the target to be watched.

A further aspect of the present invention is directed to a display system including: a surrounding object recognition unit configured to detect another moving object and an object including a fixed object existing near a vehicle and to recognize positions of targets; and a display device mounted on the vehicle. The display system is configured to control image to be displayed by the display device to cause the display device to display an image corresponding to the object in a vicinity of the object or in a position superimposed on the object, based on the position of the object recognized by the surrounding object recognition unit in such a manner that the driver of the vehicle can visually perceive the image. The display system further includes an exaggerating representation processing unit that is configured to, in a case where the surrounding object recognition unit recognizes the another moving object, regard this another moving object as a target to be watched and generate an image with exaggerating representation corresponding to the object existing near the target to be watched, and causes the image to be displayed in a position superimposed on the object existing near the target to be watched.

The present invention thus provides a display method, display device, and display system that can display images that are simpler, more readily understandable, and not annoying, compared to alerting displays with letters, signs, etc. or the display of an image corresponding to, e.g. a traffic participant to which the user should pay attention, and that can allow the user to grasp the speed and risk of such a traffic participant earlier.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram illustrating a vehicle to which the display method, display device, and display system of an embodiment is applied;

FIG. 2 is a configuration diagram showing an example of a head-up display (HUD) as an example of a virtual image display device;

FIG. 3 is a configuration diagram showing an example of a head-mounted display (HMD) as an example of the virtual image display device;

FIG. 4 is a diagram showing an example of the display of a situation where, at an intersection, an oncoming vehicle (a target to be watched) traveling in the opposite direction is approaching;

FIG. 5A is an explanatory diagram used to explain an example display of an image of a thickened mark on the lane markings of the travel path along which the oncoming vehicle, as a target to be watched, is running;

FIG. 5B is an explanatory diagram used to explain an example display of an image of an extra number of surrounding objects, e.g., roadside trees, lining the travel path along which the oncoming vehicle as a target to be watched is running;

FIG. 6 is a flowchart showing an example of a process for displaying the image shown in FIG. 5A;

FIG. 7 is a flowchart showing an example of a process for displaying the image shown in FIG. 5B;

FIG. 8A is an explanatory diagram used to explain an example display of an apparent symbolized image (virtual icon) on the travel path along which the oncoming vehicle as a target to be watched is running;

FIG. 8B is an explanatory diagram used to explain an example display of an image of a larger-sized vehicle on the travel path along which the oncoming vehicle as a target to be watched is running;

FIG. 9 is a flowchart showing an example of a process for displaying the image shown in FIG. 8A;

FIG. 10 is a flowchart showing an example of a process for displaying the image shown in FIG. 8B;

FIG. 11A is an explanatory diagram used to explain an example of the display of an exaggerating representation in which the road on which the oncoming vehicle, as a target to be watched, is running is viewed in a dark color (with extremely lowered luminance);

FIG. 11B is an explanatory diagram used to explain an example of the display of an exaggerating representation in which the road that a person, as an object to be watched, is crossing is viewed in a dark color (with extremely lowered luminance);

FIG. 12 is a flowchart showing an example of a process for displaying the image shown in FIG. 11A;

FIG. 13A is an explanatory diagram used to explain an example of an exaggerating representation in which the road on which the oncoming vehicle, as a target to be watched, is running is viewed in a dark color, with a highlighting display of a marker having a higher luminance contrast;

FIG. 13B is an explanatory diagram used to explain an example of the display of an exaggerating representation in which the road that a person, as a target to be watched, is crossing is viewed in a dark color (with extremely lowered luminance), with a highlighting display of a marker having a higher luminance contrast; and

FIG. 14 is a flowchart showing an example of a process for displaying the image shown in FIG. 13A.

### DESCRIPTION OF THE PREFERRED EMBODIMENTS

The display method, display device, and display system according to the present invention will be described in detail below in connection with preferred embodiments while referring to the accompanying drawings.

The inventors have utilized the biological features (A), (B) and (C) of the speed perception of humans.

(A) A target to be attentively watched looks as if it is moving faster if the density of objects surrounding the target is higher.

(B) A relatively small-sized target to be attentively watched looks as if it is moving faster than a relatively large-sized target.

(C) The speed of a moving target to be attentively watched having a higher luminance contrast to the background is less likely to be underestimated than the speed of a moving target having a lower luminance contrast.

This embodiment has been configured based on the features (A), (B), and (C) above. For example, when a user (mainly, a driver) in a vehicle is induced to pay attention to “a target to be watched, or a traffic participant (specifically, an oncoming vehicle, pedestrian, etc. involving high collision risks)”, a head-up display, for example, displays an image of an exaggerating representation corresponding to a “surrounding object” existing near the target, in a position superimposed on the “surrounding object”. In this case, no image corresponding to the “target to be watched or traffic participant” is displayed in a superimposed position.

Examples of the exaggerating representation include techniques to cause a head-up display, for example, which will be described later, to display images generated by the methods (1) to (6) listed below:

(1) display thickened marks on the opposite lane markings;

(2) display an image of an extra number of roadside trees (shrubs), buildings, people, etc. at the roadside;

(3) display an “icon” image for the oncoming, nearest vehicle, where the “icon” image is sized larger than the appearance of the oncoming vehicle and moved slowly;

(4) display a slowly moving “virtual icon” image representing the oncoming, nearest vehicle;

(5) display an image of the background road surface in a dark color with lower luminance, to thereby increase the luminance contrast to the oncoming, nearest vehicle or crossing pedestrian; and

(6) display a marker having a high luminance contrast to the road surface in the ground position of the oncoming, nearest vehicle or crossing pedestrian.

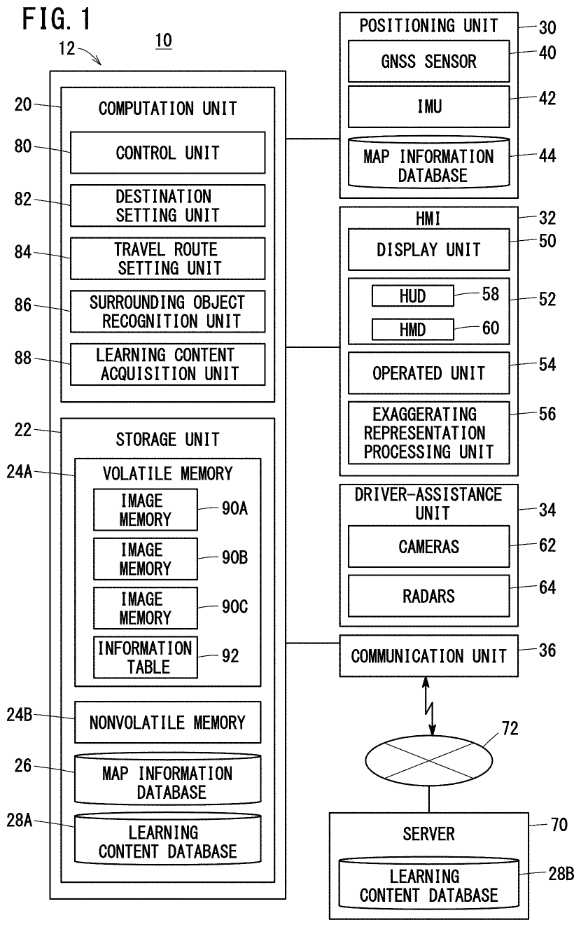

Next, a vehicle 10 to which the display method, display device and display system of an embodiment is applied will be described referring to FIGS. 1 to 3.

As shown in FIG. 1, the vehicle 10 is equipped with a display control device (display system) 12. An example in which the display control device 12 functions also as a navigation device will be described herein, but the invention is not limited to this example. A display control device 12 and a navigation device may be provided as separate devices.

As shown in FIG. 1, the display control device 12 includes a computation unit 20 and a storage unit 22. The computation unit 20 is composed of one or more processors, for example. Such processors can be CPUs (Central Processing Units), for example.

The storage unit 22 includes a volatile memory 24A and a nonvolatile memory 24B. The volatile memory 24A can be a RAM (Random Access Memory), for example. The nonvolatile memory 24B can be a ROM (Read Only Memory), flash memory, or the like, for example. Programs, maps, etc. are stored in the nonvolatile memory 24B, for example. The storage unit 22 may further include an HDD (Hard Disk Drive), SSD (Solid State Drive), etc. The storage unit 22 includes a map information (geographic information) database 26 and a learning content database 28A, for example.

Connected to the display control device 12 are a positioning unit 30, an HMI (Human Machine Interface) 32, a driver-assistance unit 34, and a communication unit 36, for example.

The positioning unit 30 includes a GNSS (Global Navigation Satellite System) sensor 40. The positioning unit 30 further includes an IMU (Inertial Measurement Unit) 42 and a map information (geographic information) database 44. The positioning unit 30 can specify the position of the vehicle 10 by using information obtained by the GNSS sensor 40, information obtained by the IMU 42, and map information stored in the map information database 44, as necessary. The positioning unit 30 supplies the display control device 12 with information indicating the position of the vehicle 10, i.e. the current position.

The HMI 32 accepts operational inputs made by a user (vehicle occupant) and provides various information to the user. The HMI 32 includes a display unit 50, a virtual image display device 52, an operated unit 54, and an exaggerating representation processing unit 56, for example. The virtual image display device 52 can include a head-up display 58 (hereinafter referred to as “HUD 58”), and an optical see-through, head-mounted augmented reality goggles, i.e. a head-mounted display 60 (hereinafter referred to as “HMD 60”), for example.

The display unit 50 provides, visually, the user with various information regarding maps and external communications. The display unit 50 can be a liquid-crystal display, organic EL display, or the like, for example, but it is not limited to these examples.

The virtual image display device 52 displays information from the exaggerating representation processing unit 56, that is, images (symbolized image) generated by the above-mentioned exaggerating representation, for example toward a front panel. Example configurations of the HUD 58 and HMD 60 will be described later as typical examples of the virtual image display device 52.

The operated unit 54 accepts operational inputs from the user. If the display unit 50 includes a touchscreen panel, the touchscreen panel functions as the operated unit 54. The operated unit 54 supplies the display control device 12 with information corresponding to the operational inputs from the user.

The driver-assistance unit 34 includes a plurality of cameras 62 for capturing images of the surroundings of the vehicle 10, and a plurality of radars 64 etc. for detecting objects surrounding the vehicle 10.

The communication unit 36 performs wireless communications with external equipment. The external equipment may include a server (external server) 70, for example. The server 70 contains a learning content database 28B, for example. Communications between the communication unit 36 and the server 70 are carried out through a network 72, such as the Internet, for example.

The computation unit 20 of the display control device 12 includes a control unit 80, a destination setting unit 82, a travel route setting unit 84, a surrounding object recognition unit 86, and a learning content acquisition unit 88. The control unit 80, destination setting unit 82, travel route setting unit 84, surrounding object recognition unit 86, and learning content acquisition unit 88 are realized by the computation unit 20 executing programs stored in the storage unit 22.

The control unit 80 controls the entire display control device 12. The destination setting unit 82 sets the destination based on the user's operations performed through the operated unit 54 etc.

The travel route setting unit 84 reads map information corresponding to the current position from the map information database 44 stored in the positioning unit 30. As mentioned above, information indicating the current position, or the position of the vehicle 10, is supplied from the positioning unit 30. By using the map information, the travel route setting unit 84 determines the target route from the current position to the destination, i.e. the travel route of the vehicle 10.

The surrounding object recognition unit 86 recognizes objects existing in the surroundings (surrounding objects) based on information from the cameras 62 and radars 64 of the driver-assistance unit 34. That is, the surrounding object recognition unit 86 recognizes what the surrounding objects are.

Specifically, mainly based on information from the cameras 62 and radars 64, the surrounding object recognition unit 86 records the captured images of surrounding objects onto an image memory (for convenience, referred to as “first image memory 90A”) in the volatile memory 24A. Based on the recorded images, the surrounding object recognition unit 86 recognizes that the surrounding objects are lane markings, roadside trees, people at the roadsides, buildings, etc.

The recognition of surrounding objects by the surrounding object recognition unit 86 can be achieved using a trained “neural network” that has been trained using training data acquired by the learning content acquisition unit 88, including information regarding various surrounding objects accumulated in the learning content database 28A of the storage unit 22 and the learning content database 28B of the server 70.

Further, the surrounding object recognition unit 86 records into an information table 92 of the storage unit 22 the kind(s) of one or more recognized surrounding objects and the position(s) of one or more surrounding objects (e.g., address(es) etc.) on the first image memory 90A.

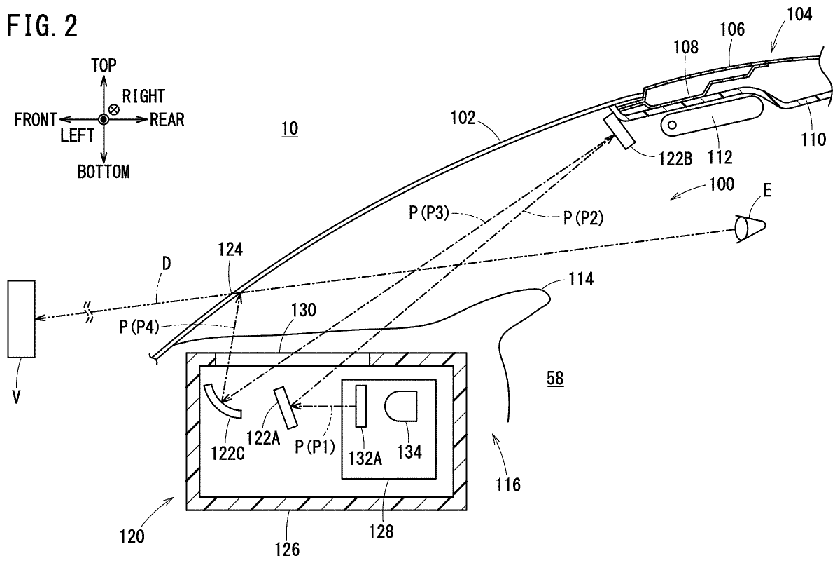

On the other hand, as shown in FIG. 2, as to the HUD 58, a windshield is provided between the front of the vehicle compartment 100 and the outside of the vehicle 10, and a front panel 102 is provided on the windshield. The upper end of the front panel 102 is connected to a roof 104. The roof 104 includes a roof panel 106 and a front roof rail 108 having their respective front ends joined together, and an interior member 110 positioned on the vehicle compartment 100 side of the roof 104. A sun visor 112 is attached at a front portion of the interior member 110. On the other hand, the lower side of the front panel 102 faces toward a dashboard 114 in the vehicle compartment 100. The HUD 58 is installed in the vehicle compartment 100 in a position near the front panel 102.

The HUD 58 includes a HUD unit 120 mounted inside the dashboard 114, a second reflector 122B attached to the roof 104 in a position near the front panel 102, and an image formation area 124 as part of the front panel 102.

The HUD unit 120 is positioned in front of the driver's seat, and includes a projector 128, a first reflector 122A, and a third reflector 122C that are contained in a resin casing 126. The casing 126 has a transparent window 130 that allows light to pass through from inside to outside or from outside to inside.

As shown in FIG. 2, in this embodiment, projected light P (P1, P2, P3, P4) travels from the projector 128 to the image formation area 124 to display an image on the image formation area 124.

Now, the optical components provided in the optical path of the projected light P will be described in order. The projector 128 includes a first display panel 132A for displaying an image, and an illumination unit 134 for illuminating the first display panel 132A. The first display panel 132A is a liquid-crystal panel, for example, which displays an image according to commands outputted from a control device (not shown). The illumination unit 134 is an LED or projector, for example. The illumination unit 134 illuminates the first display panel 132A, whereby the projected light P (P1) containing the image displayed in the first display panel 132A is emitted from the projector 128.

The first reflector 122A is located in the optical path of the projected light P (P1) emitted from the projector 128. The first reflector 122A is a convex mirror that reflects the incident projected light P (P1) in a form enlarged in the width direction of the vehicle 10.

The second reflector 122B is provided outside the casing 126 and located in the optical path of the projected light P (P2) reflected at the first reflector 122A. The second reflector 122B is attached to the front roof rail 108, or more specifically at the front end part of the front roof rail 108. The second reflector 122B is a convex mirror that reflects the incident projected light P (P2) in a form enlarged in the width direction of the vehicle 10.

The third reflector 122C is located in the optical path of the projected light P (P3) reflected at the second reflector 122B. The third reflector 122C is a concave mirror that reflects the incident projected light P (P3) in a form enlarged in the length direction and/or height direction of the vehicle 10.

The image formation area 124 is located in the optical path of the projected light P (P4) reflected at the third reflector 122C, which is a front panel 102 that forms the image contained in the incident projected light P (P4) to thereby allow an occupant in the vehicle 10 to visually perceive the image.

With the HUD 58, the projected light P (P1) emitted from the projector 128 is reflected at the first reflector 122A in the direction toward the roof 104, and transmitted out of the casing 126 through the window 130. After that, the projected light P (P2) is reflected at the second reflector 122B toward the HUD unit 120 and transmitted through the window 130 into the casing 126 through the window 130 again. After that, the projected light P (P3) is reflected at the third reflector 122C and transmitted through the window 130 to reach the image formation area 124. The image contained in the projected light P (P4) is formed on the image formation area 124 and then the eye E of the driver perceives a virtual image V at a distance corresponding to the length of the optical path.

The exaggerating representation processing unit 56 depicts a symbolized image that the driver can perceive as the virtual image V through the HUD 58, on an image memory (for convenience, referred to as “second image memory 90B”) of the first display panel 132A, in a location in the vicinity of the position (address) of the surrounding object recorded in the information table 92. If the surrounding object includes a plurality of roadside trees around the oncoming vehicle, for example, it depicts an image of roadside trees as a symbolized image, for example between the roadside trees in the image. This image of roadside trees as a symbolized image can be visually perceived by the driver as the virtual image V, for example, through the HUD 58 as explained above.

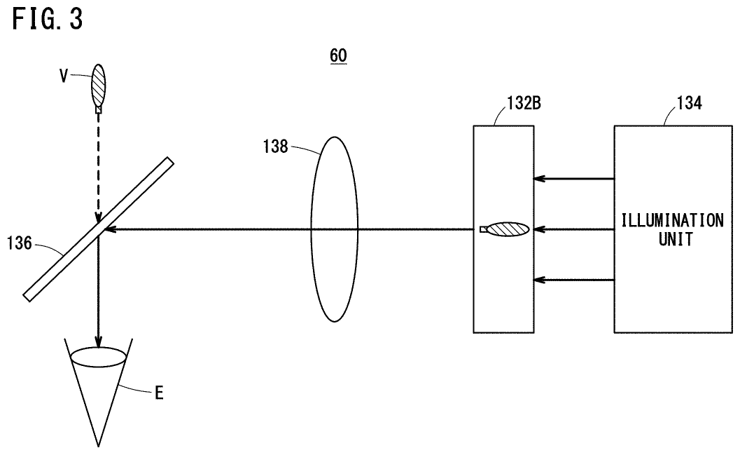

On the other hand, as shown in FIG. 3, the optical see-through HMD 60 includes a second display panel 132B provided in the goggles, an illumination unit 134 provided in the rear of the second display panel 132B to illuminate the second display panel 132B with illumination light, an optically transmissive reflecting mirror 136, and a projection lens 138 provided between the second display panel 132B and the reflecting mirror 136. The reflecting mirror 136 is half reflecting and half transmitting, allowing the user to see the outside scene.

Then, the light emitted from the illumination unit 134 passes through the second display panel 132B, travels via the projection lens 138 and the reflecting mirror 136, and enters the driver's eye E, where the image displayed in the second display panel 132B is formed directly on the retina of the driver. The driver's eye E thus perceives the virtual image V at a distance corresponding to the length of the optical path.

Thus, the exaggerating representation processing unit 56 depicts a symbolized image that the driver can recognize as the virtual image V through the HMD 60, on an image memory (for convenience, referred to as “third image memory 90C”) of the second display panel 132B, in a location in the vicinity of the position (address) of the surrounding object recorded in the information table 92. In this way, as in the case of the HUD 58 described above, it depicts in the second display panel 132B an image of, for example, roadside trees, as a symbolized image, between the roadside trees in the image. This image of roadside trees as a symbolized image can thus be perceived by the driver as the virtual image V.

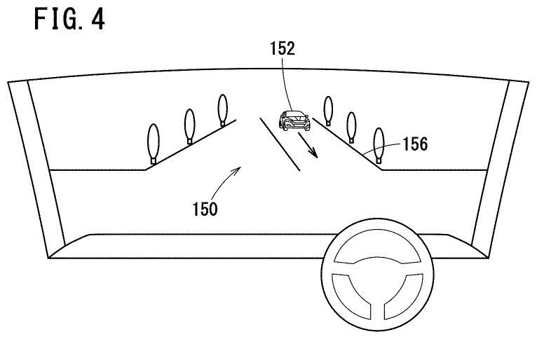

Next, methods for displaying various symbolized images (first to sixth display methods) performed by the exaggerating representation processing unit 56 will be described referring to FIGS. 4 to 14. As shown in FIG. 4, the methods assume an example situation where, at an intersection 150, an oncoming vehicle 152 traveling in the opposite direction is approaching.

### [First Display Method]

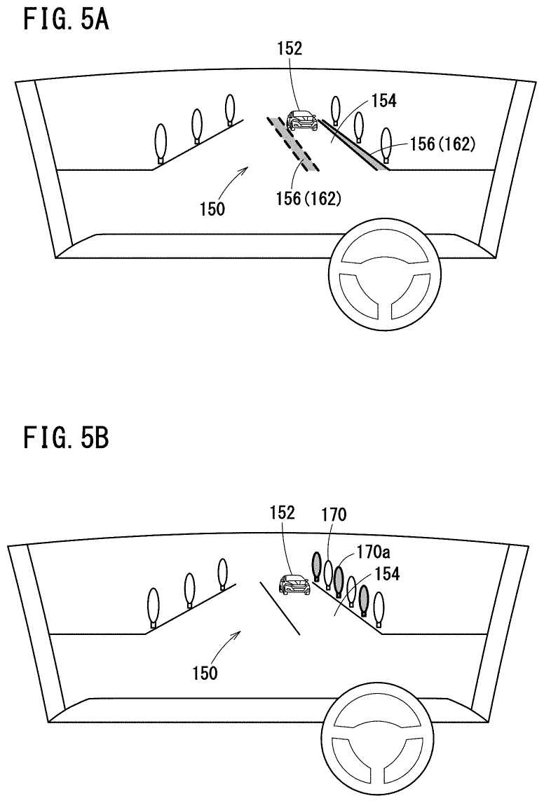

As shown in FIG. 5A, a first display method displays an image of a thickened mark on lane markings 156 in the travel path 154 along which the oncoming vehicle 152, as a target to be watched (a target to which attention should be paid), is running. In this case, the road looks narrower and the high density of the objects around the watched target causes the driver to feel as if the target to be watched, or the oncoming vehicle 152 in this example, is moving faster.

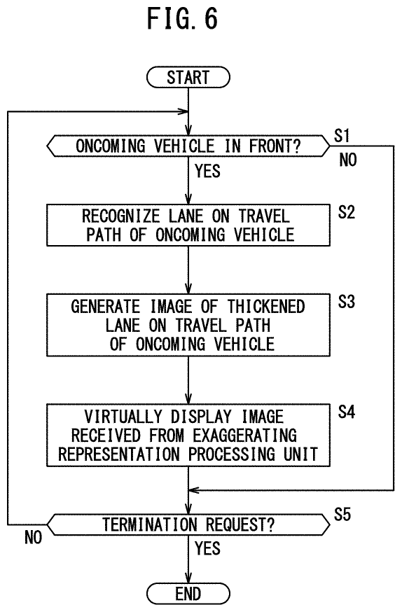

An example of this display processing will be described referring to the flowchart of FIG. 6.

First, in step S1, the vehicle 10 determines, using the cameras, radars, etc., whether an oncoming vehicle 152 is present ahead of it.

If an oncoming vehicle 152 is present in front, the process moves to step S2, where the surrounding object recognition unit 86 recognizes the lane markings 156 in the travel path of the oncoming vehicle 152 (see FIG. 4).

In step S3, as shown in FIG. 5A, the exaggerating representation processing unit 56 generates an image of a thickened mark for the lane markings 156 in the travel path of the oncoming vehicle 152 and outputs the generated image to the virtual image display device 52 (HUD 58 or HMD 60).

In step S4, the virtual image display device 52 (HUD or HMD) outputs the image received from the exaggerating representation processing unit 56 toward the front panel 102 of the vehicle 10 (see FIG. 2). Then, as shown in FIG. 5A, an exaggerated image 162 of thickened lane markings is superimposed on the lane markings 156 in the travel path 154 along which the oncoming vehicle 152 is running.

In step S5, a determination is made as to whether a termination request (e.g. the stopping of the vehicle 10) is present. The operations in and after step S1 are repeated in the absence of a termination request, and the display process is ended if a termination request is present.

### [Second Display Method]

As shown in FIG. 5B, a second display method displays an image of an extra number of surrounding objects, e.g. roadside trees 170, lining the travel path 154 of the oncoming vehicle 152 as a target to be watched. In this example, an image of roadside trees 170a as a symbolized image is displayed between a plurality of images of roadside trees 170 alongside the oncoming vehicle 152. In this case, by displaying an exaggerating image of an increased number of surrounding objects (roadside trees 170 in this example) lining the travel path 154 (road) along which the oncoming vehicle 152 is moving, the road 154 looks narrower and the high density of the objects around the target to be watched (oncoming vehicle 152) causes the driver to feel as if the oncoming vehicle 152 as the watched target is moving faster.

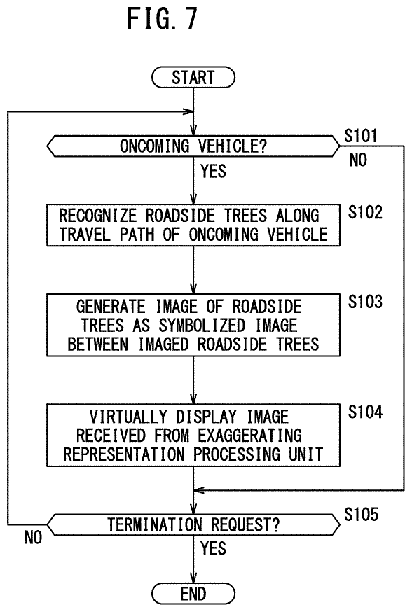

An example of this display processing will be described referring to the flowchart of FIG. 7.

First, in step S101, the vehicle 10 determines, using the cameras, radars, etc., whether an oncoming vehicle 152 is present ahead of it.

If an oncoming vehicle 152 is present in front, the process moves to step S102, where the surrounding object recognition unit 86 recognizes the roadside trees 170 alongside the oncoming vehicle 152.

In step S103, the exaggerating representation processing unit 56 generates an image of roadside trees as a symbolized image, between the roadside trees in the image, and outputs it to the virtual image display device 52 (HUD 58 or HMD 60).

In step S104, the virtual image display device 52 (HUD or HMD) outputs the image received from the exaggerating representation processing unit 56 toward the front panel 102 of the vehicle 10. Then, as shown in FIG. 5B, an extra image of the roadside trees 170a is displayed between the roadside trees 170 alongside the travel path 154 along which the oncoming vehicle 152 is running.

In step S105, a determination is made as to whether a termination request (e.g. the stopping of the vehicle 10) is present. The operations in and after step S101 are repeated in the absence of a termination request, and the display process is ended if a termination request is present.

### [Third Display Method]

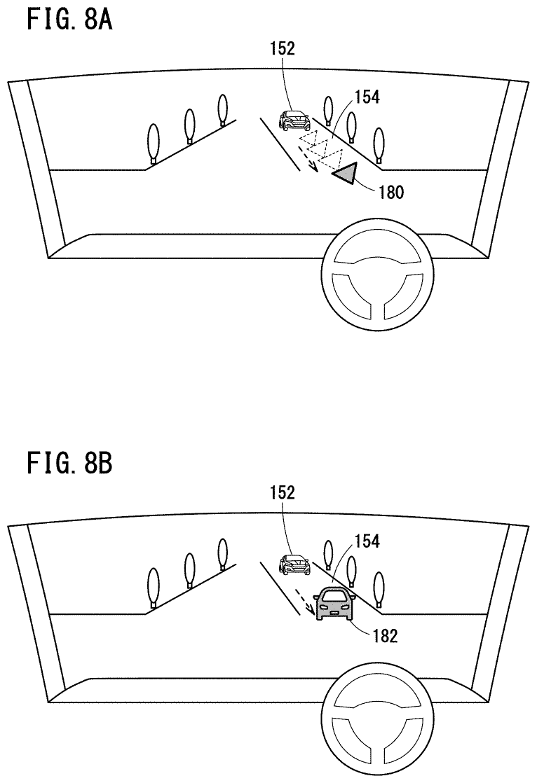

As shown in FIG. 8A, a third display method displays a virtual (symbolized) image 180 of another traffic participant having a size different from the apparent size of the oncoming vehicle 152 (e.g., a virtual icon that is larger in size than the oncoming vehicle 152 as a watched target), on the travel path 154 along which the oncoming vehicle 152 as a watched target is running, where the symbolized image 180 is moved slower than the oncoming vehicle 152. In this case, the speed of the symbolized image 180 may be zero, i.e., it may be stationary. FIG. 8A shows an example in which the virtual icon 180 is represented by an inverted triangle, but the representation is not limited to this example.

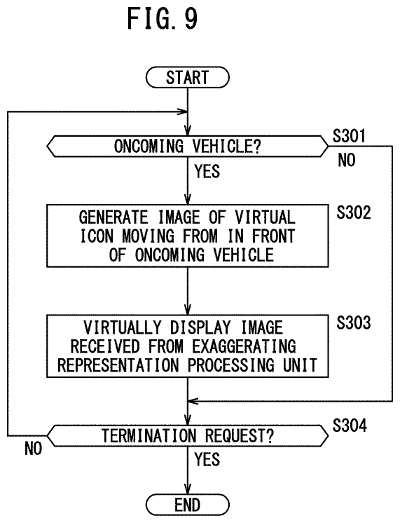

An example of this display processing will be described referring to the flowchart of FIG. 9.

First, in step S301, the vehicle 10 determines, using the cameras, radars, etc., whether an oncoming vehicle 152 is present ahead of it.

If an oncoming vehicle 152 is present in front, the process moves to step S302, where the exaggerating representation processing unit 56 generates a symbolized image (virtual icon 180) that moves from in front of the moving, oncoming vehicle 152 along the direction of travel of the oncoming vehicle 152, and outputs it to the virtual image display device 52 (HUD 58 or HMD 60). In this case, the exaggerating representation processing unit 56 may generate an image in which the virtual icon 180 moves slowly or moves while flashing and output it to the virtual image display device 52. Alternatively, the exaggerating representation processing unit 56 may generate an image in which the virtual icon 180 is standing still in front of or at the rear of the oncoming vehicle 152 and output it to the virtual image display device 52.

In step S303, the virtual image display device 52 outputs the image received from the exaggerating representation processing unit 56 toward the front panel 102 of the vehicle 10. Thus, as shown in FIG. 8A, the virtual icon 180 that is moving slowly, or standing still, or moving while flashing, is displayed in the direction of travel of the oncoming vehicle 152.

In step S304, a determination is made as to whether a termination request (e.g. the stopping of the vehicle 10) is present. The operations in and after step S301 are repeated in the absence of a termination request, and the display process is ended if a termination request is present.

### [Fourth Display Method]

As shown in FIG. 8B, a fourth display method displays a nearby object, e.g., an exaggerated image 182 of the nearest, oncoming vehicle, on the travel path 154 along which the oncoming vehicle 152 as a watched target is running, where the exaggerated image 182 is sized larger than the apparent size of the oncoming vehicle (exaggerating representation, e.g. an image of a vehicle that is larger in size than the oncoming vehicle 152 as the watched target).

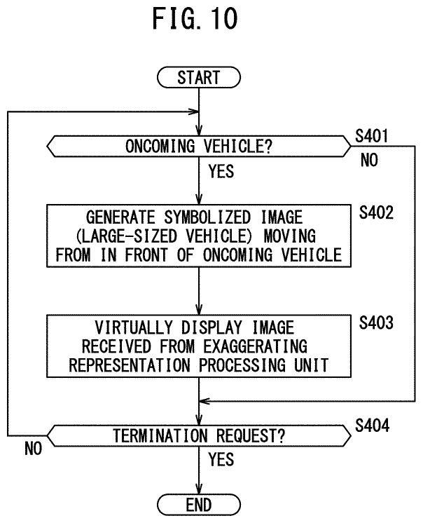

An example of this display processing will be described referring to the flowchart of FIG. 10.

First, in step S401, the vehicle 10 determines, using the cameras, radars, etc., whether an oncoming vehicle 152 is present ahead of it.

If an oncoming vehicle 152 is present in front, the process moves to step S402, where the exaggerating representation processing unit 56 generates the exaggerated image 182 that has a larger apparent size than the oncoming vehicle 152 and that is moving from in front of the moving oncoming vehicle 152 along the direction of travel of the oncoming vehicle 152, and outputs it to the virtual image display device 52 (HUD 58 or HMD 60). In this case, the exaggerating representation processing unit 56 may generate the exaggerated image 182 moving slowly and output it to the virtual image display device 52. Alternatively, the exaggerating representation processing unit 56 may generate the virtual image 182 standing still in front of or at the rear of the oncoming vehicle 152 and output it to the virtual image display device 52.

In step S403, the virtual image display device 52 outputs the image received from the exaggerating representation processing unit 56 toward the front panel 102 of the vehicle 10. Thus, as shown in FIG. 8B, the virtual image 182 having a larger size and moving slowly or standing still is displayed in the direction of travel of the oncoming vehicle 152.

In step S404, a determination is made as to whether a termination request (e.g. the stopping of the vehicle 10) is present. The operations in and after step S401 are repeated in the absence of a termination request, and the display process is ended if a termination request is present.

### [Fifth Display Method]

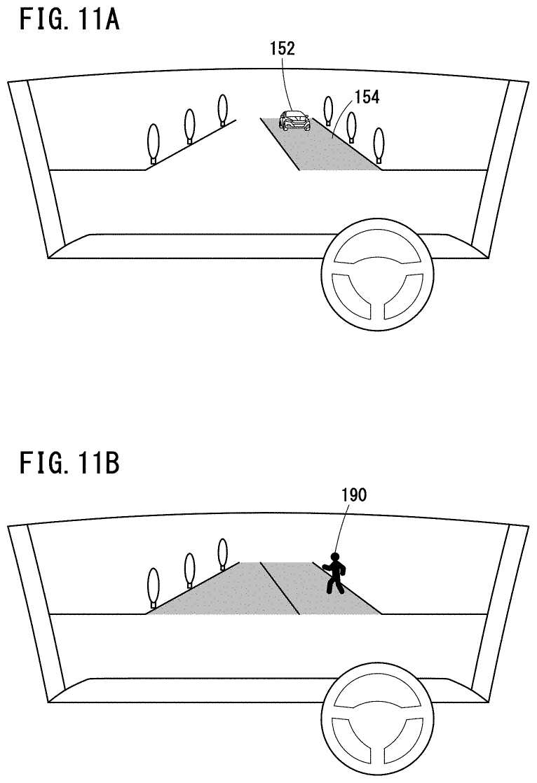

As shown in FIG. 11A, a fifth display method makes an exaggerating representation in which a nearby object on the travel path 154 of the oncoming vehicle 152 as a watched target, e.g., the road on the side of the nearest oncoming vehicle 152, is viewed in a dark color (with extremely lowered luminance).

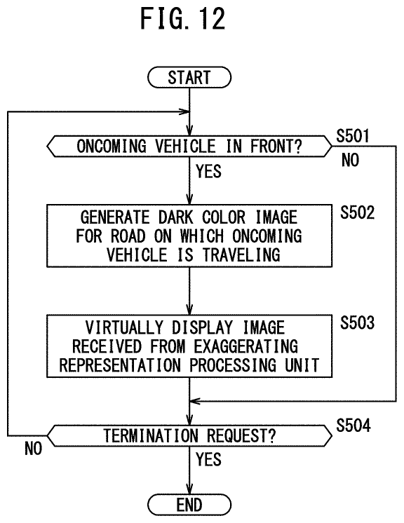

An example of this display processing will be described referring to the flowchart of FIG. 12.

First, in step S501, the vehicle 10 determines, using the cameras, radars, etc., whether an oncoming vehicle 152 is present ahead of it.

If an oncoming vehicle 152 exists in front, the process moves to step S502, where the exaggerating representation processing unit 56 generates an exaggerating representation image in which the road along which the oncoming vehicle 152 is running is viewed in a dark color (with extremely lowered luminance).

After that, in step S503, the exaggerating representation processing unit 56 outputs the exaggerating representation image to the virtual image display device 52 (HUD 58 or HMD 60). The virtual image display device 52 outputs the image received from the exaggerating representation processing unit 56 onto the front panel 102 of the vehicle 10. Thus, as shown in FIG. 11A, a virtual image of the road along which the oncoming vehicle 152 is running is displayed in a dark color.

In step S504, a determination is made as to whether a termination request (e.g. the stopping of the vehicle 10) is present. The operations in and after step S501 are repeated in the absence of a termination request, and the display process is ended if a termination request is present.

As shown in FIG. 11B, the process above may be performed in the same way when a person 190, an animal, etc., as a target to be watched, crosses the road in front, by displaying an exaggerating representation of the road in a dark color (with extremely lowered luminance).

### [Sixth Display Method]

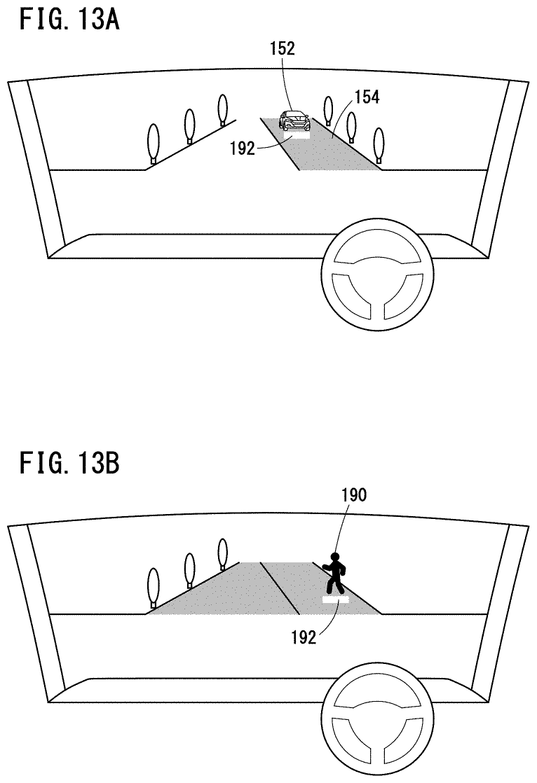

As shown in FIG. 13A, like the fifth display method above, a sixth display method makes an exaggerating representation on the travel path 154 of the oncoming vehicle 152 as a target to be watched, e.g., the road on the side of the nearest oncoming vehicle 152 is viewed in a dark color (with extremely lowered luminance). In addition, the sixth display method makes a highlighting display of a marker 192 with a high luminance contrast (relatively high luminance) in a position near the oncoming vehicle 152, on the ground of the road on which the oncoming vehicle 152 exists.

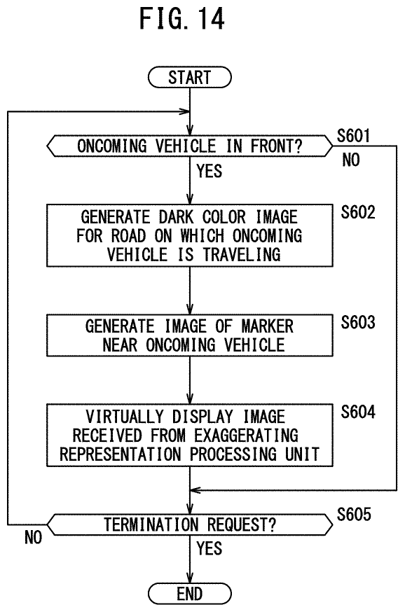

An example of this display processing will be described referring to the flowchart of FIG. 14.

First, in step S601, the vehicle 10 determines, using the cameras, radars, etc., whether an oncoming vehicle 152 is present ahead of it.

If an oncoming vehicle 152 exists in front, the process moves to step S602, where the exaggerating representation processing unit 56 generates an exaggerating representation image in which the road 154 along which the oncoming vehicle 152 is running is viewed in a dark color (with extremely lowered luminance).

Further, in step S603, the exaggerating representation processing unit 56 generates a highlighting representation image of the marker 192 with a high luminance contrast (relatively high luminance) in a position near the oncoming vehicle 152, on the ground of the road on which the oncoming vehicle 152 exists.

After that, in step S604, the exaggerating representation processing unit 56 outputs the exaggerating representation image including the highlighting display image to the virtual image display device 52 (HUD 58 or HMD 60).

In this step S604, the virtual image display device 52 outputs the image received from the exaggerating representation processing unit 56 onto the front panel 102 of the vehicle 10. Thus, as shown in FIG. 13A, a virtual image is displayed in which the road 154 that the oncoming vehicle 152 is running is viewed in a dark color, with the marker 192 having a high luminance contrast (with relatively high luminance) drawn in a position near the oncoming vehicle 152, on the ground of the road on which the oncoming vehicle 152 exists.

In step S605, a determination is made as to whether a termination request (e.g. the stopping of the vehicle 10) is present. The operations in and after step S601 are repeated in the absence of a termination request, and the display process is ended if a termination request is present.

As shown in FIG. 13B, the process above may be performed in the same way when a person 190, an animal, etc., as a target to be watched, is crossing the road in front, by displaying the exaggerating representation of the road 154 in a dark color (with extremely lowered luminance) and the highlighting representation of the marker 192 having a high luminance contrast (with relatively high luminance) in a position near the person 190, animal, or the like.

The embodiments described above can be summarized as follows.

An embodiment provides a display method for use in a moving object (vehicle 10 in the embodiment) having a display device (virtual image display device 52). The display method detects at least another moving object (e.g. oncoming vehicle 152) and an object including a fixed object (e.g. roadside trees 170), and displays an image, by the display device, in the vicinity of the detected object or in a position superimposed on the detected object. When the display method detects another moving object, the display method regards this another moving object as a target to be watched, generates an image of an exaggerating representation corresponding to the object existing near the target to be watched, and causes the display device to display the image in a position superimposed on the object existing near the target to be watched.

In general, in a situation where an object that is viewed in a relatively far distance (a moving object like a vehicle or a pedestrian) is moving at higher relative velocity and involves a higher risk of collision than a nearest moving object (e.g. a moving object like a vehicle or a pedestrian) and relatively nearby objects, it may be desirable to perceive the speed of this “collision-risky” “traffic participant” earlier.

The display method according to the embodiment enables the driver to grasp the speed and risk more quickly, by making use of “features of the perception of speed of humans” by adopting the method above. The method can display not annoying but simpler and readily understandable images and allow the driver to grasp the speed and risk more quickly, as compared to alerting indications with letters, signs, etc. (corresponding to the “watched target and traffic participant”).

The display method above regards another traffic participant involving a high collision risk as a target to be watched, and does not display a virtual image corresponding to the watched target around or in a position superimposed on the real view of the watched target.

In this way, the image can be less annoying but simpler and readily understandable because no image corresponding to the “watched target or traffic participant” (a moving object like a vehicle or pedestrian), to which the user should pay attention, is superimposed on the real “watched target or traffic participant” (like an oncoming vehicle involving a high collision risk).

In the display method above, the exaggerating representation displays an image of a thickened mark on the lane marking on the travel path along which the target to be watched moves.

By displaying an image of a thickened lane marking (surrounding object) in the travel path (road) of the watched target, the road looks narrower and the high density of objects around the watched target causes the driver to feel as if the watched target is moving faster.

In the display method above, the exaggerating representation displays an image of an extra number of surrounding objects along the travel path along which the target to be watched moves.

When an image of an increased number of surrounding objects (roadside trees (shrubs), buildings, people, etc.) lining the travel path (road) of the target to be watched (an exaggerating representation) is displayed, the road looks narrower and the high density of the objects around the watched target causes the driver to feel the speed of the watched target to be faster.

In the display method above, the exaggerating representation displays a symbolized surrounding image of a nearby object (e.g. the nearest, oncoming vehicle) having a larger size than the real apparent size, on the travel path along which the target to be watched moves.

By displaying an image of a surrounding object having a larger size than the real apparent size on the travel path of the watched target (an exaggerating representation), the road looks narrower and the high density of the objects around the watched target causes the driver to feel the speed of the watched target to be faster.

In the display method above, the display device displays, as the image corresponding to another traffic participant, a virtual image with exaggerating representation having a different apparent size from the target to be watched, on the travel path along which the target to be watched moves.

When a virtual image of another traffic participant having a different apparent size from the watched target (a virtual icon sized larger than the watched target) is displayed on the travel path of the watched target in such a manner that it moves slower than the watched target (including zero speed, or it may be stationary), the speed of the watched target feels faster.

In the display method above, the exaggerating representation displays a virtual image of a road surface having a different luminance from the target to be watched, on the travel path along which the target to be watched moves. When the background road surface is viewed in a dark color with reduced luminance so as to enhance the luminance contrast between the moving, watched target and the background road surface, it is then possible to avoid the conventionally known phenomenon that the speed of a moving object having a lower contrast is likely to be underestimated.

In the display method above, the exaggerating representation displays a virtual image of a road surface having a different luminance from the target to be watched, on the travel path along which the target to be watched moves, and the display method further displays a marking image corresponding to the target to be watched in such a manner that the marking image has a different luminance from the virtual image of the road surface and moves together with the target to be watched. When a marker having a high luminance contrast to the background road surface is displayed on the ground as if it is moving together with the watched target, it is possible to avoid the phenomenon of underestimating the moving speed of the watched target, by referring to the correctly perceived moving speed of the marker.

A display device (52) according to an embodiment includes a surrounding object recognition unit (86) configured to recognize at least another moving object (e.g. oncoming vehicle 152) and an object including a fixed object (e.g. roadside trees 170), and the display device is configured to display an image in the vicinity of, or in a position superimposed on, the object recognized by the surrounding object recognition unit. The display device includes an exaggerating representation processing unit (56) that is configured to, when the surrounding object recognition unit recognizes another moving object, regard this another moving object as a target to be watched and generate an image of an exaggerating representation corresponding to a surrounding object existing near the target to be watched, and the display device displays the image in a position superimposed on the surrounding object.

Thus, it is possible to simultaneously effect the conventionally available “highlighting display” and the above-described “exaggerating display”. It is thus possible to provide a relatively simpler and readily understandable image and allow the driver to grasp the speed and risk of the watched target at an earlier stage, i.e. more quickly.

A display system (12) according to an embodiment includes: a surrounding object recognition unit (86) configured to detect, as a target, another moving object and an object including a fixed object existing near a vehicle (10), and to recognize the position of the target; and a display device mounted on the vehicle. The display system is configured to control the image display made by the display device to cause the display device to display an image corresponding to the object based on a position of the object recognized by the surrounding object recognition unit, in such a manner that the driver of the vehicle can visually perceive the image in the vicinity of the object or in a position superimposed on the object. The display system further includes an exaggerating representation processing unit (56) that is configured to, when the surrounding object recognition unit recognizes another moving object, regard this another moving object as a target to be watched and generate an image of an exaggerating representation corresponding to a surrounding object existing near the target to be watched, and the image is displayed in a position superimposed on the surrounding object.

Thus, it is possible to simultaneously effect the conventionally available “highlighting display” and the above-described “exaggerating display”. It is thus possible to provide a relatively simpler and readily understandable image and allow the driver to grasp the speed and risk of the watched target at an earlier stage, i.e. more quickly.

While preferred embodiments of the present invention have been described above, the present invention is not limited to the embodiments above but can be modified in various ways without departing from the essence and gist of the invention.

What is claimed is:

1. A display method for use in a moving object comprising a display device, the display method comprising: detecting at least another moving object and an object including a fixed object, and displaying an image, by the display device, in a vicinity of the object detected or in a position superimposed on the object detected,
wherein, in a case where the display method detects the another moving object, the display method regards the another moving object as a target to be watched, generates an image with exaggerating representation corresponding to the object existing near the target to be watched, and causes the display device to display the image in a position superimposed on the object existing near the target to be watched.

2. The display method according to claim 1, wherein in a case where the display method regards another traffic participant involving a high collision risk as the target to be watched, the display method does not display a virtual image corresponding to the target to be watched around or in a position superimposed on a real view of the target to be watched.

3. The display method according to claim 1, wherein the exaggerating representation displays an image of a thickened mark on a lane marking on a travel path along which the target to be watched moves.

4. The display method according to claim 1, wherein the exaggerating representation displays an image of the object existing near the target to be watched in an extra number along a travel path along which the target to be watched moves.

5. The display method according to claim 1, wherein the exaggerating representation displays an image of the object existing near the target to be watched in a larger size than a real apparent size thereof, on a travel path along which the target to be watched moves.

6. The display method according to claim 1, wherein the display device displays, as the image corresponding to another traffic participant, a virtual image with exaggerating representation having a different apparent size from the target to be watched, on a travel path along which the target to be watched moves.

7. The display method according to claim 1, wherein the exaggerating representation displays a virtual image of a road surface having a different luminance from the target to be watched, on a travel path along which the target to be watched moves.

8. The display method according to claim 1, wherein
the exaggerating representation displays a virtual image of a road surface having a different luminance from the target to be watched, on a travel path along which the target to be watched moves, and
the display method further displays a marking image corresponding to the target to be watched in such a manner that the marking image has a different luminance from the virtual image of the road surface and moves together with the target to be watched.

9. A display device comprising a surrounding object recognition unit configured to recognize at least another moving object and an object including a fixed object, the display device being configured to display an image in a vicinity of, or in a position superimposed on, the object recognized by the surrounding object recognition unit,
the display device comprising one or more processors, wherein when the surrounding object recognition unit recognizes the another moving object, the one or more processors regard the another moving object as a target to be watched and generate an image with exaggerating representation corresponding to the object existing near the target to be watched, and
the display device displays the image with exaggerating representation in a position superimposed on the object existing near the target to be watched.

10. A display system comprising a surrounding object recognition unit configured to detect, as a target, another moving object and an object including a fixed object existing near a vehicle, and to recognize a position of the target, and a display device mounted on the vehicle, the display system being configured to control image display made by the display device to cause the display device to display an image corresponding to the object based on the position of the object recognized by the surrounding object recognition unit, in such a manner that a driver of the vehicle can visually perceive the image in a vicinity of the object or in a position superimposed on the object,
wherein the display system further comprises an exaggerating representation processing unit that is configured to, when the surrounding object recognition unit recognizes the another moving object, regard the another moving object as a target to be watched and generate an image with exaggerating representation corresponding to the object existing near the target to be watched, and the display device displays the image in a position superimposed on the object existing near the target to be watched.
